(19) United States
(12) Patent Application Publication
(10) Pub. No.: US 2002/0036216 A1
(43) Pub. Date: Mar. 28, 2002

(54) Filling station and method for dispensing liquid fuel at such a filling station

(75) Inventor: Bengt I. Larsson, Skivarp (SE)

Correspondence Address: JENKENS & GILCHRIST, P.C., 3200 Fountain Place, 1445 Ross Avenue, Dallas, TX, 75202-2799, US

(73) Assignee: Dresser, Inc.

(21) Appl. No.: 09/960,651

(22) Filed: Sep. 21, 2001

(30) Foreign Application Priority Data
Sep. 22, 2000 (SE) 0003377-9

(51) Int. Cl. B67D 3/00

(52) U.S. Cl. 222/481

(57) ABSTRACT

In a method for dispensing liquid fuel at a filling station, which comprises at least two delivery nozzles which each via a fuel line with associated metering means are in fluid communication with a fuel container, the fuel is made, when a large flow of fuel from a selected delivery nozzle is required to flow from the fuel container to the selected delivery nozzle via at least two fuel lines with associated metering means.

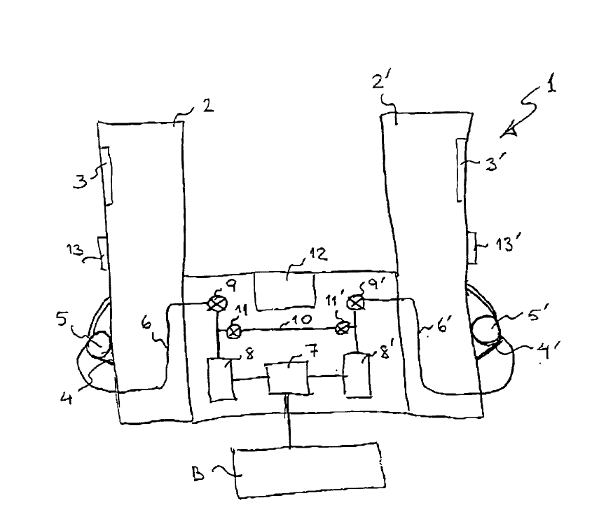

The filling station suitably comprises a controllable valve means which is adapted, when a large flow of fuel through the selected delivery nozzle is required, to open the fluid connection between the fuel lines downstream of the metering means.

### TECHNICAL FIELD

The present invention relates generally to a filling station and a method for dispensing liquid fuel at such a filling station, above all for providing motor vehicles, such as trucks, passenger cars, boats, etc., with fuel.

### BACKGROUND ART

FR 8208878 describes an example of a filling station, which comprises a pump which supplies fuel from a fuel container via a metering means to a delivery nozzle, by means of which the fuel is supplied to a vehicle. During filling-up, the pump operates continuously, and as long as the delivery nozzle remains closed, the fuel is made to circulate in a bypass line in connection with the pump. EP 0440845A1 describes another example of a filling station, which has two delivery nozzles which via a metering means each are served by one and the same pump. Also in this case, excess fuel is made to circulate in a bypass line in connection with the continuously operating pump. To prevent excess flows in the bypass line when none or only one of the delivery nozzles is open, the capacity of the pump is controlled on the basis of the flow rate in the bypass line or on the basis of the number of open delivery nozzles.

At filling stations of this type it is sometimes desirable to obtain different maximum flows of fuel. For instance, the maximum fuel flow should be larger when filling the tank of a truck compared with a passenger car for the filling operation to be effected in a reasonable time. At prior art filling stations, it is difficult to provide such different maximum fuel flows in one and the same delivery unit, i.e. the combination of a pump, a metering means and a delivery nozzle. An increase of the fuel flow which by means of the pump is passed through the metering means to the delivery nozzle results in a still greater increase of the pressure drop over the metering means. This increasing pressure drop can be understood as a decreasing electric efficiency of the filling station. In practice, the filling station is therefor equipped with delivery units which are designated for filling exclusively with small maximum fuel flows (e.g. for passenger cars) or with larger maximum fuel flows (e.g. for trucks). Such specialized filling stations, however, have a higher cost of erection.

It is also difficult, with a maintained low pressure drop and maintained great measuring accuracy, to easily modify existing filling stations for passenger cars so that also trucks can be filled up.

### SUMMARY OF THE INVENTION

An object of the present invention is to overcome the above drawbacks in an easy and reliable manner.

This object is wholly or partly achieved by a filling station comprising at least two delivery nozzles which via a fuel line each are in fluid communication with at least one pump means which is adapted to supply liquid fuel from a fuel container to the delivery nozzles via a metering means arranged in the respective fuel lines, wherein at least two of said fuel lines are in fluid communication with each other downstream of the metering means via a controllable valve means, the valve means being adapted to open, when dispensing of a large flow of fuel through a selected delivery nozzle is required.

The object of the invention is also achieved by a method for dispensing liquid fuel at a filling station comprising at least two delivery nozzles, which each via a fuel line with associated metering means are in fluid communication with a fuel container, wherein the fuel, when a large flow of fuel from a selected delivery nozzle is required, is made to flow from the fuel container to the selected delivery nozzle via at least two fuel lines with associated metering means.

Preferred embodiments are defined in the dependent claims.

When a larger maximum fuel flow is required, for instance for filling up a truck, the controllable valve means can be made to open so that fuel can be supplied to one and the same delivery nozzle via a plurality of existing metering means which are each adapted to smaller fuel flows, for instance for filling up passenger cars. Thus, the fuel flow through the respective metering means can be kept down and the pressure drop over the same can be minimized. It should also be noted that the larger maximum fuel flow is achieved by connecting existing metering means which normally (i.e. when s filling up with a lower maximum fuel flow) do not serve the selected delivery nozzle.

Since the filling station and the method according to the invention allow distribution of the fuel flow among a plurality of metering means, it is also possible to use metering means which are optimized for a narrower flow range and which thus can be given greater measuring accuracy. As an example, it can be mentioned that filling stations for passenger cars typically contains metering means with great measuring accuracy in the flow ranger of about 4-40 l/min. Since the fuel flow, at a filling station and a method according to the invention, can be distributed among a plurality of such metering means, great measuring accuracy is achieved also at higher flow rates, such as 80 or 120 l/min.

It should be pointed out that existing filling stations, which are arranged for filling up within a given flow range, e.g. for filling up passenger cars, can easily be modified for filling up with a maintained low pressure drop and maintained great accuracy within a wider flow range, e.g. for filing up trucks, by installing the controllable valve means according to the invention. In this context, use is made of metering means which are associated with different delivery nozzles and which, before installation of the valve means, would be in any case have been out of use when filling up by means of a selected delivery nozzle.

### DESCRIPTION OF THE PREFERRED EMBODIMENT

The present invention will now be described in more detail with reference to the accompanying drawing which schematically illustrates a presently preferred embodiment of a filling station according to the invention.

The filling station 1 shown in the drawing comprises two separate delivery units or fuel pump units 2, 2′. The delivery units 2, 2′ can be provided with a display 3, 3′ for showing the filled-up quantity of fuel. Each delivery unit 2, 2′ has a yoke 4, 4′ for receiving a delivery nozzle 5, 5′ which via a fuel line 6, 6′ is connected to a pump 7 which is common to the two delivery units 2, 2′ and supplies fuel from a fuel container (B). Between the pump 7 and each delivery nozzle 5, 5′, a metering means 8, 8′ is arranged, for instance an electronic pulse generator of the type described in applicant's Swedish Patents 9604076.1 (U.S. Pat. No. 5,869,757) and 9604075.3 (U.S. Pat. No. 5,929,314). Moreover, the pump 7 can be provided with a conventional filter and gas separator (not shown). Any pump suitable in the context can be used, thus also a continuously operating pump of the type described by way of introduction, fitted with a bypass line. In each fuel line 6, 6′, between the metering means 8, 8′ and the delivery nozzle 5, 5′, a valve 9, 9′, such as a solenoid valve, is arranged to controllably close and open the connection between the pump 7 and the delivery nozzle 5, 5′. Moreover, the fuel lines 6, 6′ are interconnected upstream of the metering means 8, 8′ via a connecting line 10 having a control valve 11, 11′, such as a solenoid valve, at each end. A central control unit 12 monitors and controls the filling procedure, by operation of the pump 7 and the valves 9, 9′, 11, 11′.

In the filling operation, the user can select the type of vehicle by means of a key set 13, 13′ on each delivery unit 2, 2′. If the user, on the delivery unit 2′ to the right in the drawing, selects a type of vehicle, for instance truck, which implies filling up with a large maximum fuel flow, the control unit 12 controls the valves 9′, 11, 11′ to open whereas the valve 9 remains closed. Subsequently, the user can fill up his vehicle at a high maximum flow rate via the delivery nozzle 5′. It should be emphasized that the central unit 12 is arranged to receive measuring signals from the two metering means 8, 8′ and, by adding up, calculate the total quantity of fuel which, for instance, can be shown on the display 3′. The central unit 12 is also designed to detect whether the other delivery nozzle 5 has been removed from its yoke 4 and, in that case, immediately close the valves 11, 11′ and, preferably simultaneously, reduce the flow through the metering means 8′. Thus, the filling-up continues in the delivery unit 2′ to the right, possibly at a lower flow rate, while simultaneously the delivery unit 2 to the left is ready for use.

The invention is not limited to the embodiment described above, and several modifications are feasible within the scope of protection as defined by the appended claims. For instance, the filling station 1 may comprise a plurality of pumps, more specifically one pump for each delivery unit 2, 2. Furthermore, the connecting line 10 can be fitted with only one valve which is capable of blocking the flow in both directions through the same. Alternatively, the filling station 1 may have only one delivery unit which is adapted to fill up both passenger cars and trucks. In this case, it is sufficient to arrange in the connecting line only one controllable one-way valve which opens towards the delivery nozzle of the selected delivery unit. It should also be pointed out that one and the same delivery unit may comprise a plurality of delivery nozzles, for instance for different types of fuel.

What is claimed is:

1. A filling station comprising at least two delivery nozzles which via a fuel line each are in fluid communication with at least one pump means which is adapted to supply liquid fuel from a fuel container to the delivery nozzles via a metering means arranged in the respective fuel lines, wherein at least two of said fuel lines are in fluid communication with each other downstream of the metering means via a controllable valve means, the valve means being adapted to open, when dispensing of a large flow of fuel through a selected delivery nozzle is required.

2. A filling station as claimed in claim 1, wherein the valve means is adapted to automatically close when another one of said delivery nozzles is actuated.

3. A filling station as claimed in claim 1, wherein the valve means comprises two controllable valves which are arranged adjacent to and in fluid communication with a fuel line each and which are in fluid communication with each other.

4. A method for dispensing liquid fuel at a filling station comprising at least tow delivery nozzles, which each via a fuel line with associated metering means are in fluid communication with a fuel container, wherein the fuel, when a large flow of fuel from a selected delivery nozzle is required is made to flow from the fuel container to be selected delivery nozzle via at least two fuel lines with associated metering means.

5. A method as claimed in claim 4, wherein the step of making fuel flow from the fuel container to the selected delivery nozzle is automatically interrupted when another one of the delivery nozzles associated with said at least two fuel lines is actuated.
